(19) United States
(12) Patent Application Publication
(10) Pub. No.: US 2002/0169511 A1
(43) Pub. Date: Nov. 14, 2002

(54) Pointing device with a display panel

(76) Inventor: Yu-Chih Cheng, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,555

(22) Filed: Sep. 19, 2001

(30) Foreign Application Priority Data
May 11, 2001 (TW) 090111349

(51) Int. Cl. G05B 15/00; G05B 11/01

(52) U.S. Cl. 700/85; 700/84; 700/83; 700/17

(57) ABSTRACT

A pointing device has a shell, a displacement signal generator for generating pointing signals, a display panel installed on the shell for displaying information, and a control circuit installed in the shell for controlling the pointing device. When another display has too many windows, a user may transfer some of windows on the display panel to the display panel of the pointing device to display information.

### BACKGROUND OF INVENTION

1. Field of the Invention

The present invention relates to a pointing device, and more particularly, to a pointing device with a display panel.

2. Description of the Prior Art

Information/communications processing tools, such as personal computers, notebook computers, and personal data assistants (PDAs) in the field of computer systems; the Internet, and telecommunications networks in the field of information/communications networks; and mobile phones in the field of communications systems, etc., are all offering increasingly sophisticated functionality.

The data being processed, and hence presented, by such systems is growing, so that the display device on these information/communication processing tools is increasingly important. In particular, when a user is processing a great deal of data at the same time, the information presented on the display device may often appear quite crowded.

As an example, a user of a personal computer runs a word-processing application, and needs on-line help for the word-processing application. The contents of the on-line help will occupy a portion of the computer screen, thus covering a portion of the contents of the document being processed. As another example, when a user on the Internet is reading on-line documents from Internet, he or she may require the services of an on-line dictionary. While viewing the contents of the on-line dictionary, a portion of the computer screen will cover a portion of the document being read. This obscuring of one document by another can be quite a nuisance to the user. PDAs and mobile phones also suffer from similar problems, i.e., displays crowded by too much information.

### SUMMARY OF INVENTION

It is therefore a primary objective of the present invention to provide a pointing device with a display panel to solve the above-mentioned problem.

According to claimed invention, a pointing device has a shell, a displacement signal generator for generating a pointing signal, a display panel installed on the shell for displaying information, and a control circuit installed in the shell for controlling the pointing device. When other display panels open too many windows, a user can transfer a portion of the windows on the display panel to the display panel of the pointing device to display information on the pointing device.

It is an advantage of the present invention that the pointing device has a display panel capable of displaying information, and thus allows a distribution of displayed information to ease the problem of crowding.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a diagram of a present invention pointing device.

FIG. 2 is a diagram of the pointing device in FIG. 1 connected to a notebook computer.

FIG. 3 is a diagram of a present invention mouse.

FIG. 4 is a diagram of the mouse in FIG. 3 connected to a personal computer.

FIG. 5 is a diagram of the mouse in FIG. 3 connected to a personal data assistant (PDA).

FIG. 6 is a diagram of a present invention track ball.

FIG. 7 is a diagram of the track ball in FIG. 6 connected to an information/communications network.

FIG. 8 is a diagram of the track ball in FIG. 6 connected to a mobile phone.

### DETAILED DESCRIPTION

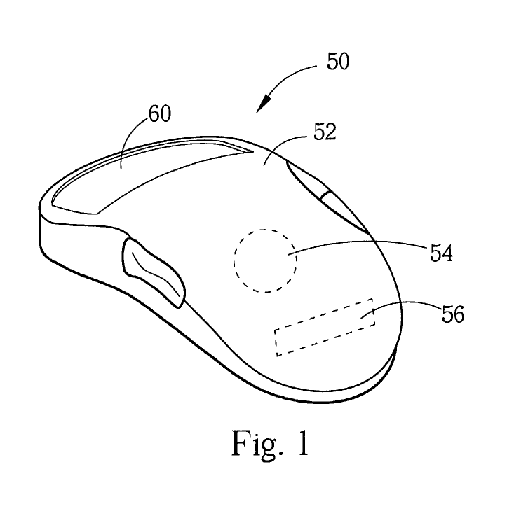

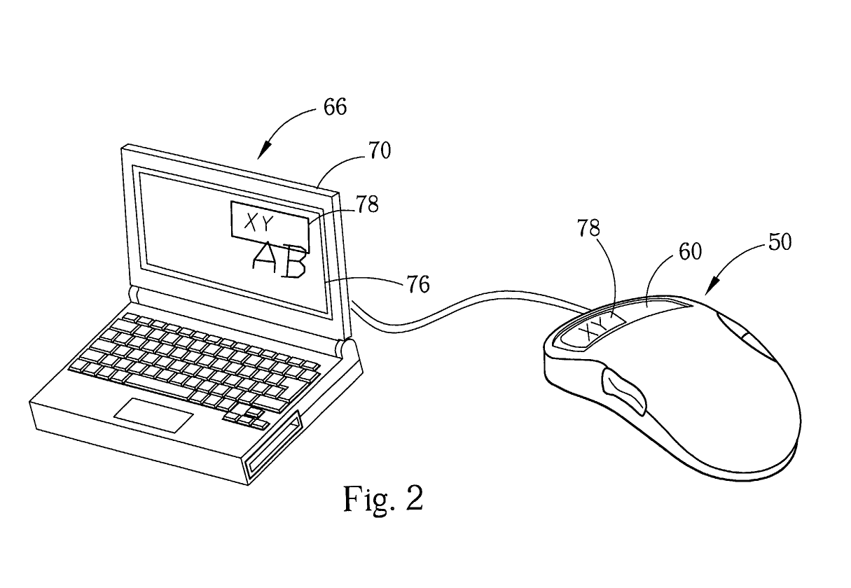

Please refer to FIG. 1. FIG. 1 is a diagram of a present invention pointing device 50. The pointing device 50 comprises a shell 52, a displacement signal generator 54 for generating pointing signals, a display panel 60 installed on the shell 52 for displaying information, and a control circuit 56 installed in the shell 52 for controlling the pointing device 50. Please refer to FIG. 2. FIG. 2 is a diagram of the pointing device 50 connected to a notebook computer 66. The notebook computer 66 has a display device 70 for displaying information. As shown in FIG. 2, when the display device 70 displays an image 78 after an image 76 has already been displayed, the image 78 will cover a portion of the area of the image 76. Instead, the notebook computer 66 may transfer the image 78 to the display panel 60 to avoid the image 78 from interfering with the displaying of the image 76 on the display device 70. By transferring the image 78 to the display panel 60 of the pointing device 50, not only is overlapping with the image 76 avoided, but the visual appearance of the pointing device is changed. Various sizes, shapes and positions of the display panel 60 on the shell 52 may be implemented. If the image 78 is an image or animation extracted from a database in the computer system 66, the pointing device 50 has the ability to serve as an electronic album. A user may display a favorite photo or image on the display panel 60 for viewing at anytime, and the displaying of this image on the display 60 will not affect normal work occurring on the display device 70.

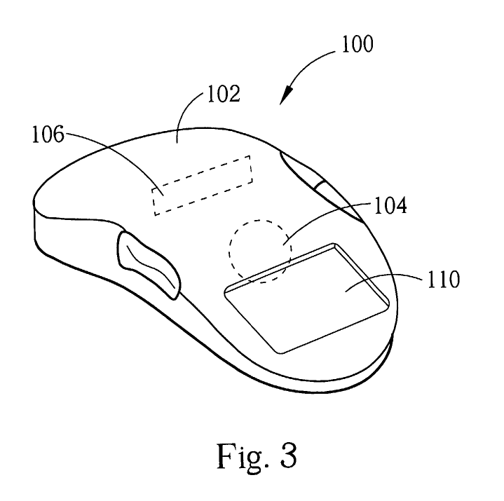

Please refer to FIG. 3. FIG. 3 is a diagram of a present invention mouse 100. The mouse 100 comprises a shell 102, a displacement signal generator 104 for generating pointing signals, a liquid crystal display (LCD) panel 110 installed on the shell 102 for displaying images, and a control circuit 106 installed in the shell 102 for controlling the mouse 100.

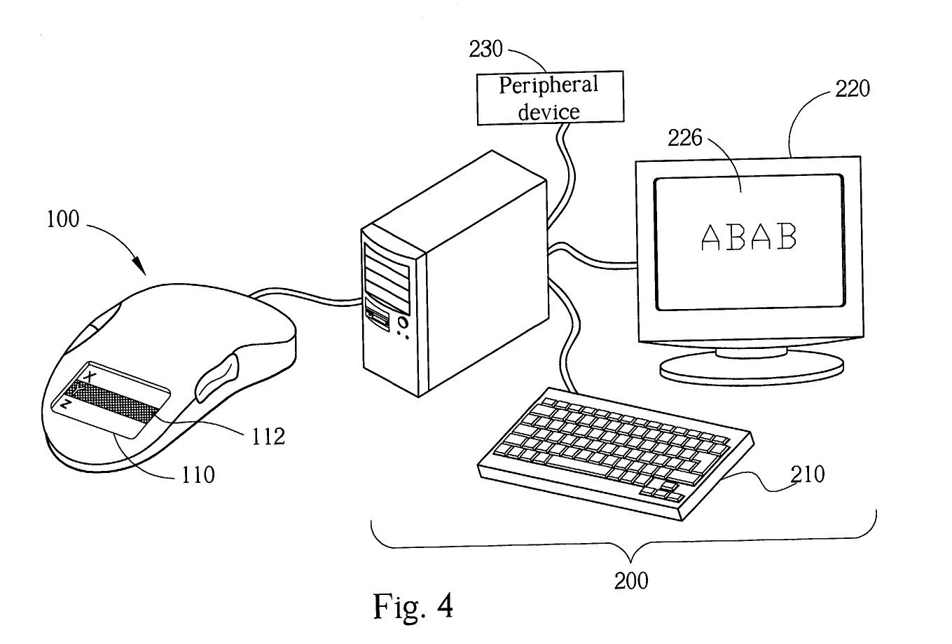

Please refer to FIG. 4. FIG. 4 is a diagram of the mouse 100 connected to a computer system 200. The computer system 200 is a personal computer, though other computer systems are possible, such as notebook computers, personal data assistants (PDAs), etc. The computer system 200 comprises a display device 200. An image 226 on the display device 220 defines a work area of an application of the computer system 200. An image 112 on the liquid crystal display panel 110 is signal window of the application, or for information related to the application. When the application executes, the signal windows are displayed according program requirements, or user-selected options. At execution, the work area 226 of the application is displayed on the display device 220 of the computer system 200. The signal windows 112 may be displayed on the liquid crystal display panel 110 of the mouse 100 so that the user can utilize information from the signal windows 112 without obscuring the work area 226.

The above-mentioned structure is useful for several different kinds of applications. For example, the signal windows may be on-line help, menus, or dialog boxes of any application. When the information presented in the signal windows 112 requires interaction, other input devices connected to the same computer system 200 can be used to provide an input interface for the signal window 112. For example, when the signal windows 12 present a menu, a keyboard 210 of the computer system 200 can be used to control and choose options within the menu. When using the computer system 200 to input words, the import methods of some languages often appear within a signal window (for example, when selecting Chinese characters as part of a keyboard 210 interface). These signal windows 112 often obscure or overlap the text to be inputted, which affects the efficiency of inputting words. With the present invention, the signals can be displayed on the liquid crystal display panel 110 to solve this problem. Some computer dictionaries (such as Dr. Eye) have the ability that, when the user points to a word, the dictionary displays a related translation, illustrative sentences, etc. However, pop-up windows for this information invariably seem to cover some important portion of the display device 220, which is a source of irritation for the user. This problem can be overcome with the present invention liquid crystal display panel 110 by displaying these pop-up windows in the signal window 112. If the computer system 200 is connected to other computer peripheral devices 230, such as printers, scanners, etc., the operations and status of the peripheral device 230 can be directly displayed on the liquid crystal display panel 110, effectively freeing display area in the display device 220. If the work area 226 of the application comprises some modular screen interface elements, such as toolbars, the screen interface elements may be displayed by the liquid crystal display panel 110. The work area is thus increased, while still being convenient to operate the application. Other applications, such as screen messages, electronic calendars, and address books, can all use the present invention to achieve similar effects.

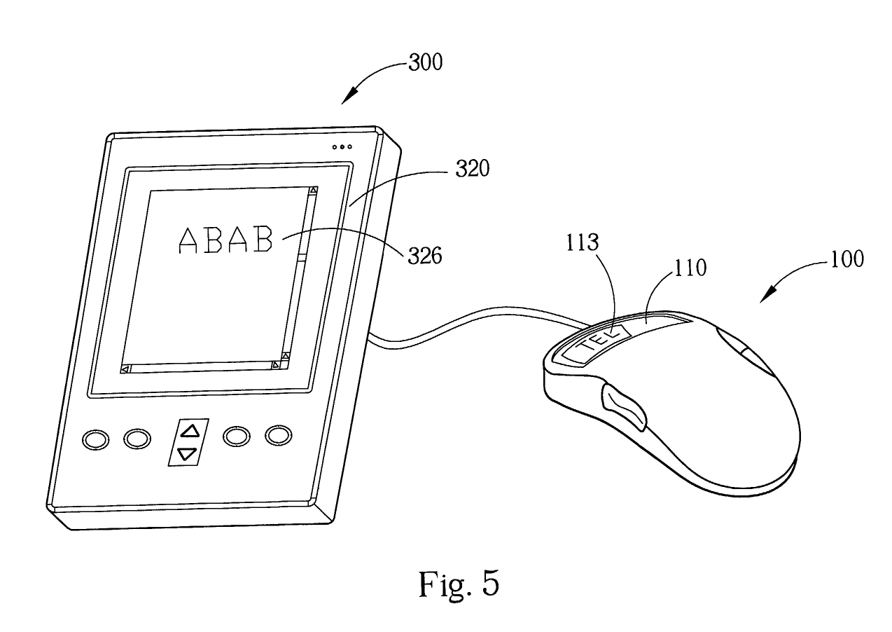

Please refer to FIG. 5. FIG. 5 is a diagram of the mouse 100 of FIG. 3 connected to a personal data assistant (PDA) 300. The personal data assistant 300 comprises a display device 320. The display device 320 displays an image 326 of an application of the personal data assistant 300. The liquid crystal display panel 110 displays an image 113 of an address book of the personal data assistant 300. When the user uses the application and the address book at the same time, the image 326 of the application is displayed on the display device 320 of the personal data assistant 300, and the image 113 of the address book is displayed on the liquid crystal display panel 110 of the mouse 100. The user can thus check the contents of the address book without affecting the image 326.

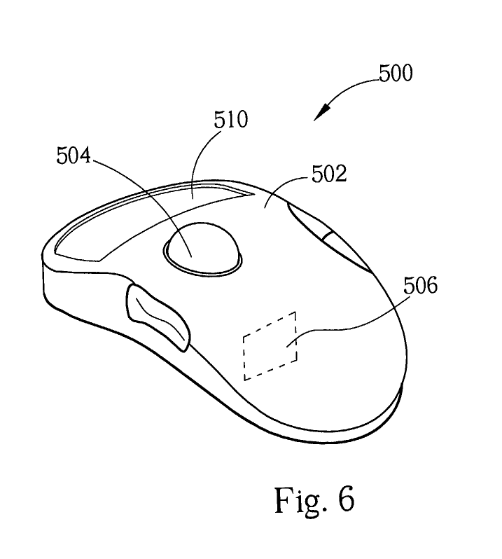

Please refer to FIG. 6. FIG. 6 is a diagram of a present invention track ball 500. The track ball 500 comprises a shell 502, a displacement signal generator 504 for generating a pointing signal, a liquid crystal display panel 501 installed on the shell 502 for displaying images, and a control circuit 506 installed in the shell 502 for controlling the track ball 500.

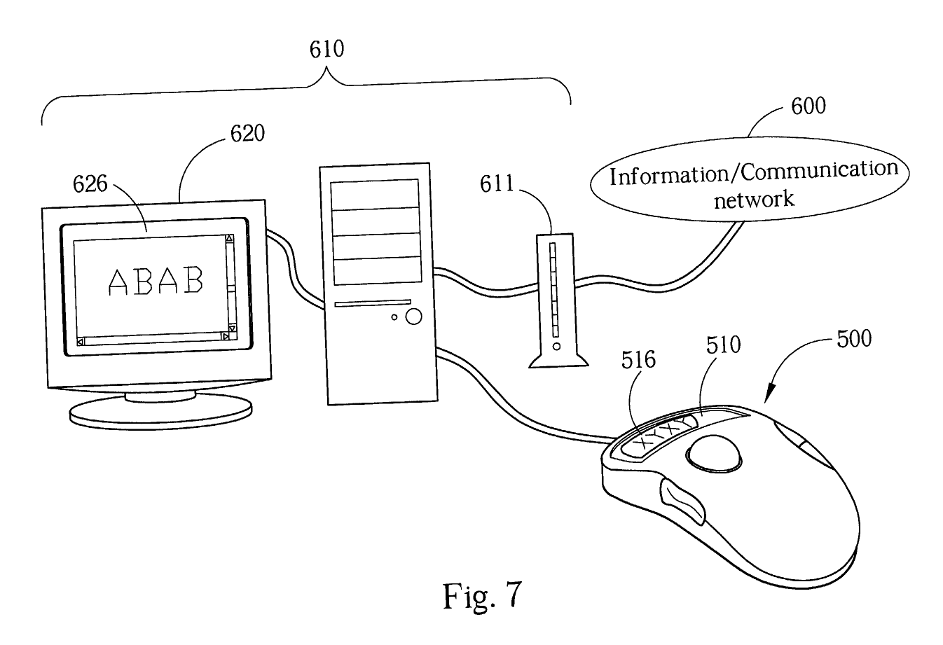

Please refer to FIG. 7. FIG. 7 is a diagram of the track ball 500 connected to a computer system 610 and an information/communications network 600. The computer system 610 connects to the information/communication network 600. The information/communications network 600 may be the Internet, a telecommunications network, or the like. The computer system 610 has a display device 620 displaying an image 626, and the liquid crystal display panel 510 on the track ball 500 displays an image 516 of on-line information from the information/communications network 600.

When the user performs jobs related to the image 626, the image 626 is displayed on the display device 620 of the computer system 610, and the image 516 of the on-line information is displayed on the liquid crystal display panel 510 of the track ball 500. The user can utilize and monitor the on-line image information 516 without obscuring or otherwise affecting the image 626. As an example, the on-line image information 516 from the network may present on-line stock quotes, on-line news, on-line weather forecasts, etc.

The structure of FIG. 7 may also be applied as a caller ID information system. A caller ID information system informs a user of related information of an in-coming call, such as the caller's phone number and the caller's identity. There are two traditional methods of providing caller ID information services. The first is to directly install a display device on the telephone. The other is to use a data communications device 611, which connects to the computer system 610 and the telecommunication network, and which utilizes the display device 620 of the computer system 610 to display the caller ID information of incoming telephone calls. With the structure of FIG. 7, the caller ID information may be treated as on-line information 516, and thus directly displayed on the liquid crystal display panel 510. In this way, the image 626 will have no chance of being obscured, while the user can still obtain information of in-coming telephone calls. Consequently, it is not necessary to buy telephones with built-in displays.

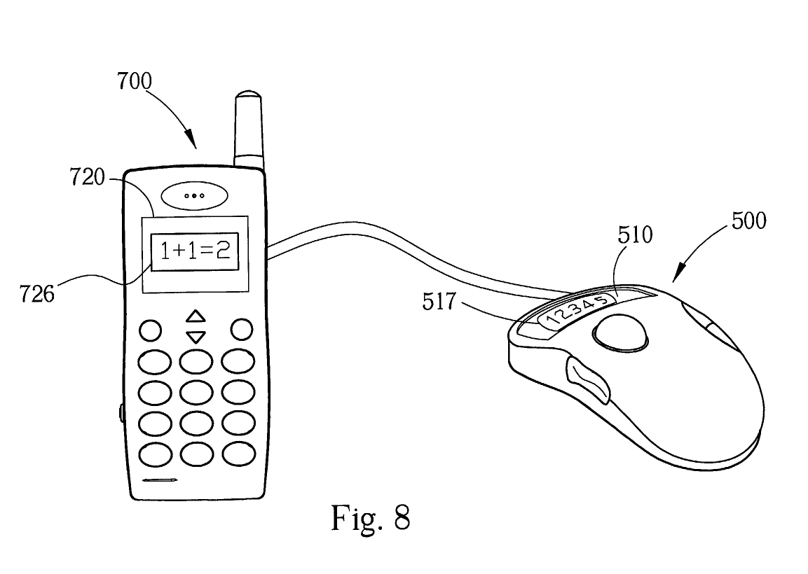

Please refer to FIG. 8. FIG. 8 is a diagram of the track ball 500 of FIG. 6 connected to a mobile phone 700. The mobile phone 700 has a display device 720, which is displaying an image 726 of a calculator (an application of the mobile phone 700). The display panel 510 of the track ball 500 is displaying an image 517 related to an incoming call of the mobile phone 700. When the user is using the calculator of the mobile phone 700 and the mobile phone 700 is connected to the track ball 500, to present a new message, the image 726 of the calculator remains displayed on the display device 720 of the mobile phone 700, and the new message is shown on the display panel 510 of the track ball 500. Operations of the calculator will thus not be affected when presenting information of in-coming telephone calls. Such an arrangement may also be used on the computer system 200 of FIG. 4, in which the user input numbers and operations with the keyboard 210, and the results are displayed on the liquid crystal display panel 110.

In the contrast to the prior art pointing device, the present invention pointing device enables the transfer of images of other display devices to the display panel of the present invention pointing device. Therefore, the present invention pointing device helps to prevent cluttering that results when too many images are displayed on a single display device.

Those skilled in the art will readily observe that numerous modifications and alterations of the device are possible while retaining the teachings of the invention. Accordingly, the above disclosure should be construed as limited only by the metes and bounds of the appended claims.

What is claimed is:

1. A pointing device comprising:
a housing;
a displacement signal generator for generating pointing signals;
a display panel installed on the housing for displaying picture images; and
a control circuit installed in the housing for controlling operations of the pointing device.

2. The pointing device of claim 1 wherein the display panel is a liquid crystal display (LCD) panel.

3. The pointing device of claim 1 being a mouse.

4. The pointing device of claim 1 being a track ball.

5. The pointing device of claim 1 being able to be connected with a computer system, wherein the display panel is capable of displaying data transmitted from the computer system.

6. The pointing device of claim 5 wherein the computer system is a notebook computer.

7. The pointing device of claim 5 wherein the computer system is a personal data assistant (PDA).

8. The pointing device of claim 1 being able to be connected with a cellular phone, wherein the display panel is capable of displaying data transmitted from the cellular phone.

9. The pointing device of claim 1 being able to be connected with a communications network, wherein the display panel is capable of displaying data transmitted from the communications network.

10. The pointing device of claim 9 wherein the communications network is an internet.

11. The pointing device of claim 9 wherein the communications network is a telecommunications network.

12. A method using a computer system to display a first picture image and a second picture image, the computer system comprising a first display device, a pointing device, and a second display device installed on the pointing device, the method comprising:
displaying the first picture image on the first display device and displaying the second picture image on the second display device to avoid displaying the first and second picture images on the first display device at the same time.

13. The method of claim 12 wherein the first picture image is a document image, and the second picture image is a message window.

14. The method of claim 12 wherein the first picture image is an application program working platform, and the second picture image comprises application program support data.

15. The method of claim 14 wherein the application program support data is online help.

16. The method of claim 14 wherein the application program support data is a selection list.

17. The method of claim 16 wherein the computer system further comprises a keyboard capable of controlling the selection list.

18. The method of claim 12 wherein the computer system further comprises a peripheral device, the second picture image displaying an operation status of the peripheral device.

19. The method of claim 12 wherein the computer system is connected to a communications network.

20. The method of claim 19 wherein the communications network is a telecommunications network, the second picture image displaying data received from the telecommunications network.

21. The method of claim 19 wherein the communications network is an internet, the second picture image displaying data received from the internet.
